(19) United States
(12) Patent Application Publication
(10) Pub. No.: US 2011/0068098 A1
(43) Pub. Date: Mar. 24, 2011

(54) Electric Heating Yarns, Methods for Manufacturing the Same and Application Thereof

(75) Inventor: Chen-Liang Li, Jhonghe City (TW)

(73) Assignee: TAIWAN TEXTILE RESEARCH INSTITUTE, Tu-Chen City (TW)

(21) Appl. No.: 12/953,928

(22) Filed: Nov. 24, 2010

Related U.S. Application Data
(63) Continuation-in-part of application No. 11/615,616, filed on Dec. 22, 2006, now Pat. No. 7,884,307.

(51) Int. Cl. H05B 3/02; H01C 17/02

(52) U.S. Cl. 219/542; 29/611

(57) ABSTRACT

Disclosed herein are electric heating yarns, methods for manufacturing the same and electric heating textile having the electric heating yarns. In one example, the electric heating yarn includes an electro-conductive yarn core and a first protective envelope. The first protective envelope is directly wound or braided around and completely covering the peripheral of the electro-conductive yarn core such that the electric heating yarn is operable to withstand a temperature of at least about 200° C. The first protective envelope is made of at least one heat-resistant yarn or electro-insulating sheet to provide water-proof ability and/or electrical insulating protection to the electro-conductive yarn core.

### CROSS-REFERENCE

The present application is a continuation-in-part application of U.S. application Ser. No. 11/615,616, filed Dec. 22, 2006, and entitled “ELECTRIC HEATING TEXTILE”, the entirety of which is incorporated herein by reference.

### BACKGROUND

1. Field of Invention

The present invention relates to electric heating yarns and methods for manufacturing the same. More particularly, the present invention relates to electric heating yarns that can withstand a temperature of at least about 200° C.

2. Description of Related Art

One advantage of electric heating textiles lies in that they are capable of conforming to the contour of the objects to be heated due to their flexibility. However, the heating temperature of conventional electric heating textiles are limited to around 60° C. thereby limiting the expanse of the application range of such electric heating textiles.

In view of the foregoing, there exists a need in the art for providing an electric heating textile capable of providing a higher heating temperature.

### SUMMARY

The following presents a simplified summary of the disclosure in order to provide a basic understanding to the reader. This summary is not an extensive overview of the disclosure and it does not identify key/critical elements of the present invention or delineate the scope of the present invention. Its sole purpose is to present some concepts disclosed herein in a simplified form as a prelude to the more detailed description that is presented later.

In one aspect, the present invention is directed to an electric heating yarn that is operable to withstand a temperature of at least about 200° C. As such, an electric heating textile employing such electric heating yarn is operable to provide a heating temperature higher than 60° C. Also, the present electric heating yarn is operable to exhibit electric-insulating and water-proof properties that meet industrial needs.

According to one embodiment of the present invention, the electric heating yarn comprises an electro-conductive yarn core and a first protective envelope. The first protective envelope is directly disposed around and completely covers the peripheral of the electro-conductive yarn core by winding or braiding at least one heat-resistant yarn or electro-insulating sheet around the peripheral of the electro-conductive yarn core so that the electric heating yarn is operable to withstand a temperature of at least about 200° C. The first protective envelope is made of at least one heat-resistant yarn or electro-insulating sheet.

In another aspect, the present invention is directed to a method for manufacturing the electric heating yarn according to the aspect/embodiments of the present invention. The electric heating yarn as-manufactured is operable to withstand a temperature of at least about 200° C. and exhibit electric-insulating and water-proof properties that meet industrial needs.

According to one embodiment of the present invention, the method comprises the steps as follows. An electro-conductive yarn core is provided, and then at least one heat-resistant yarn or electro-insulating sheet is wound or braided around the electro-conductive yarn core thereby forming a first protective envelope around and completely covering the peripheral of the electro-conductive yarn core.

In yet another aspect, the present invention is directed to an electric heating textile that is operable to provide a heating temperature higher than 60° C.

According to one embodiment of the present invention, the electric heating textile comprises a textile main body consisting of a plurality of electric heating yarns according to the aspect/embodiments of the present invention.

Many of the attendant features will be more readily appreciated as the same becomes better understood by reference to the following detailed description considered in connection with the accompanying drawings.

### BRIEF DESCRIPTION OF THE DRAWINGS

The present description will be better understood from the following detailed description read in light of the accompanying drawings, wherein:

FIG. 1 is a schematic diagram illustrating the cross-section of an electric heating yarn according to one aspect of the present invention;

FIG. 2A and FIG. 2B are schematic diagrams illustrating methods for manufacturing an electric heating yarn according to embodiments of the present invention;

FIG. 3 is a schematic diagram illustrating the cross-section of an electric heating yarn according to one optional embodiment of the present invention; and

FIG. 4A and FIG. 4B are schematic diagrams illustrating the cross-sections of electric heating yarns 400 and 450 according to other optional embodiments of the present invention.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

In view of the low heating temperature provided by the conventional electric heating textiles, a multi-layered electric heating textile capable of providing a higher heating temperature (for example, 100° C.) was provided in the co-pending application U.S. Ser. No. 11/615,616 by the inventors of the present application. Yet, the present inventors have continued to dedicate research efforts in developing novel electric heating textiles.

Specifically, the electric heating textile according to our prior application, U.S. Ser. No. 11/615,616, includes an electric heating layer, a heat-insulating layer and a protective layer. The electric heating layer includes at least one conductive yarn capable of generating heat and plural aromatic polyamide fibers. The heat-insulating layer is under the electric heating layer. The protective layer is on the electric heating layer. Also, the method for manufacturing such electric heating textile as described in the co-pending application includes the steps as follows. First, an electric heating layer as described-hereinabove is formed. Then, a heat-insulating layer and a protective layer are sewn on and under the electric heating layer, respectively. The protective layer is waterproof, rub-resistant, heat-resistant and moisture permeable layer capable of preventing the electric heating layer from being in contact with environment. In one example of in the co-pending application, the temperature of the top of the protective layer reaches 300° C., whereas the temperature of the bottom of the heat-insulating layer is only about 50° C.

To further improve the performance and durability of the electric heating textiles, the present inventors provide a novel electric heating yarn and a method for manufacturing the same.

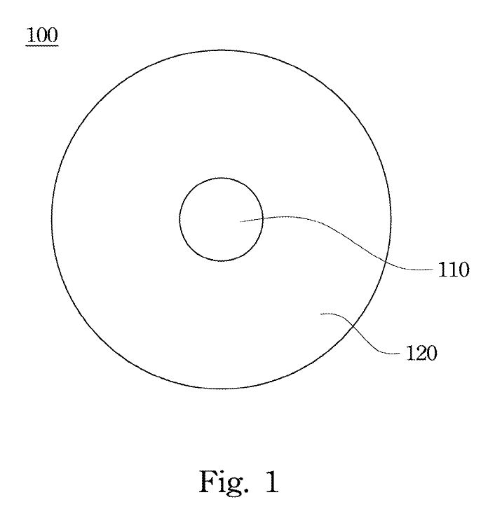

FIG. 1 is a schematic diagram illustrating the cross-section of an electric heating yarn 100 according to one aspect of the present invention. As shown in FIG. 1, the electric heating yarn 100 comprises an electro-conductive yarn core 110 and a first protective envelope 120 that is directly disposed around the peripheral of the electro-conductive yarn core 110. The first protective envelope 120 is disposed to completely cover the electro-conductive yarn 110 so as to provide electrical insulating (and waterproof) protection for the electro-conductive yarn 110. As such, the protective layer used in the co-pending application U.S. Ser. No. 11/615,616 is replaced by the first protective envelope 120 described herein, thereby providing a more satisfactory electrical insulating (and waterproof) protection.

In practice, the electro-conductive yarn core 110 may be a monofilament yarn or a multifilament yarn. Generally, a monofilament yarn is a thin string made from a single fiber, whereas a multifilament yarn consists of multitude of fine, continuous filaments usually with some twist in the yarn to facilitate handling. Sizes of the multifilament yarns range from 5-10 denier up to a few hundred denier, and individual filaments in a multifilament yarn are usually about 1 to 5 denier.

Illustrative examples of the electro-conductive yarn core 110 include, but are not limited to: stainless steel fiber, carbon fiber, and Ni—Cr fiber.

According to various embodiment of the present invention, the first protective envelope 120 is made of at least one heat-resistant yarn or electro-insulating sheet wound or braided around the electro-conductive yarn core 110. As such, the electric heating yarn 100 is operable to withstand a temperature of at least about 200° C.

Illustrative examples of the heat-resistant yarn suitable for forming the first protective envelope include, but are not limited to: a quartz fiber/yarn, a glass fiber/yarn, an oxidized fiber/yarn, an alumina fiber/yarn, a poly-p-phenylenebenzobisoxazole fiber/yarn, a poly(m-phenylene isophthalamide) fiber/yarn, a poly(p-phenylene terephthalamide) fiber/yarn, and a co-poly(para phenylene/3,4′-oxydiphenylene terephthalamide) fiber/yarn.

For the purpose of illustration, the electro-insulating sheet may be made of a material selected from polyimide and polytetrafluoroethylene.

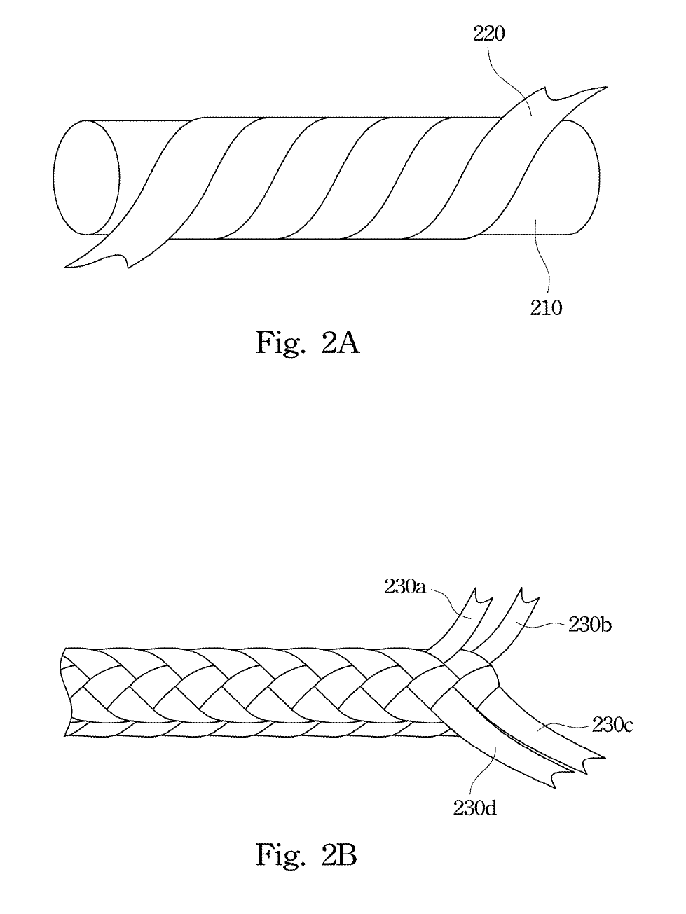

FIG. 2A and FIG. 2B are schematic diagrams illustrating methods for manufacturing an electric heating yarn (such as the electric heating yarn 100 illustrated in FIG. 1) according to embodiments of the present invention.

As shown in FIG. 2A, a heat-resistant yarn or an electro-insulating sheet 220 is wound (strapped) around the peripheral of an electro-conductive yarn core 210 in such a way to completely cover the electro-conductive yarn core 210 whereby forming a first protective envelope around the peripheral of the electro-conductive yarn core 210.

In FIG. 2B, four heat-resistant yarns or electro-insulating sheets 230a-230d are braided (intertwined) around the peripheral of an electro-conductive yarn core 210 in such a way to completely cover the electro-conductive yarn core 210 whereby forming a first protective envelope around the peripheral of the electro-conductive yarn core 210. By forming a first protective envelope directly around the peripheral of the electro-conductive yarn core, rather than sewing an additional protective layer on a textile consisting of the electro-conductive yarns, it is possible to provide a more satisfactory electrical insulating (and waterproof) protection for the electric heating textile manufactured therefrom.

As could be appreciated by those with ordinary skill in the art, the electro-conductive yarn core, the heat-resistant yarns and electro-insulating sheets described hereinabove regarding FIG. 1 are equally applicable herein.

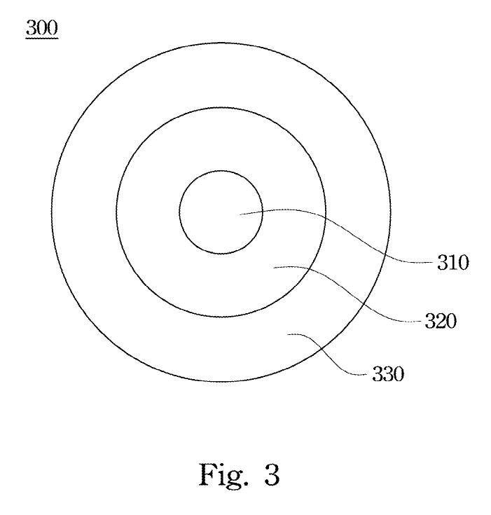

FIG. 3 is a schematic diagram illustrating the cross-section of an electric heating yarn 300 according to one optional embodiment of the present invention. As shown in FIG. 3, the electric heating yarn 300 comprises an electro-conductive yarn core 310, a first protective envelope 320 that is directly disposed around and completely covering the peripheral of the electro-conductive yarn core 310, and a second protective envelope 330 that is wound or braided around the first protective envelope 320.

According to the principles and spirits of the present application, the second protective envelope 330 is made of at least one heat-resistant yarn so as to provide the electric heating yarn 300 with an improved heat-resistant functionality in addition to the electrical insulating (and waterproof) functionality provided by the first protective envelope 320.

More specifically, in one example, the first protective envelope 320 may be made of at least one heat-resistant yarn and the second protective envelope 330 may be made of at least one heat-resistant yarn. In this case, it is preferred that the heat-resistant properties of the heat-resistant yarns of the first and second protective envelopes 320, 330 are different. For example, the heat-resistant yarn of the first protective envelope 320 that is directly disposed around the peripheral of the electro-conductive yarn core 310 could be more heat resistant than the heat-resistant yarn of the second protective envelope 330. This particular example is suitable for use in applications that do not required excellent insulating property.

In another example, the first protective envelope 320 may be made of at least one electro-insulating sheet, and the second protective envelope 330 may be made of at least one heat-resistant yarn.

In yet another example, the first protective envelope 320 may be made of at least one heat-resistant yarn, and the second protective envelope 330 may be made of at least one electro-insulating sheet.

In still another example, the first protective envelope 320 and the second protective envelope 330 may be made of electro-insulating sheets having the same or different electro-insulating properties.

As could be appreciated by those with ordinary skill in the art, the electro-conductive yarn core, the heat-resistant yarns and electro-insulating sheets described hereinabove regarding FIG. 1 are equally applicable in the embodiment illustrated in FIG. 3. Also, examples of the heat-resistant yarn(s)/electro-insulating sheet(s) suitable for forming the second protective envelope 330 is the same as those for forming the first protective envelope 120 as described herein. Accordingly, detailed descriptions regarding those materials are omitted herein for the sake of brevity. However, the adhesion properties between the materials should be taken into account when choosing suitable materials for the first and second protective envelopes.

The at least one heat-resistant yarn can be wound or braided around the peripheral of the first protective envelope 320 in accordance with the methods described hereinabove in connection with FIG. 2A and FIG. 2B. Preferably and optionally, the heat-resistant yarn is wound or braided in such a way to completely cover the peripheral of the first protective envelope 320 to provide additional insulating protection.

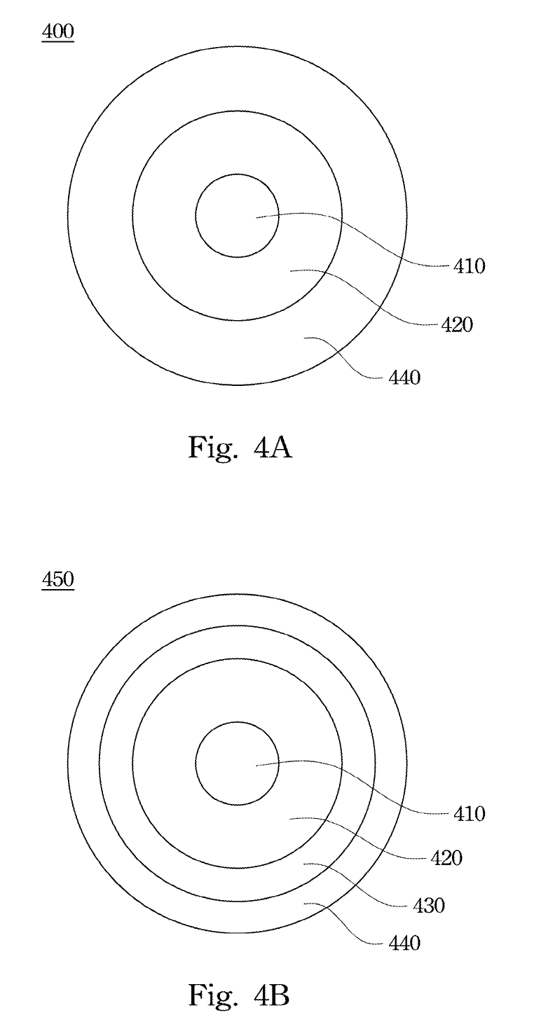

FIG. 4A and FIG. 4B are schematic diagrams illustrating the cross-sections of electric heating yarns 400 and 450 according to other optional embodiments of the present invention.

As shown in FIG. 4A, the electric heating yarn 400 comprises an electro-conductive yarn core 410, a first protective envelope 420 that is directly disposed around and completely covering the peripheral of the electro-conductive yarn core 410, and at least one grounding conductor 440 that is wound or braided around the first protective envelope 420.

In FIG. 4B, the electric heating yarn 450 comprises an electro-conductive yarn core 410, a first protective envelope 420 that is directly disposed around and completely covering the peripheral of the electro-conductive yarn core 410, a second protective envelope 430 that is wound or braided around the first protective envelope 420, and at least one grounding conductor 440 that is wound or braided around the second protective envelope 430. Generally, the grounding conductor 440 may further enhance the temperature generated by the electric heating yarns 400, 450.

The at least one grounding conductor 440 can be wound or braided around the peripheral of the first protective envelope 420 or second protective envelope 430 in accordance with the methods described hereinabove in connection with FIG. 2A and FIG. 2B. Also, the electro-conductive yarn core, the first and second protective envelopes described hereinabove regarding FIG. 1 to FIG. 3 are equally applicable in the embodiment as described herein.

Also, it should be noted that although specific number of the heat-resistant yarn, electro-insulating sheet or grounding conductor are illustrated in the appended figures to illustrate the electric heating yarns according to various embodiments of the present invention, the present invention is not limited thereto. Rather, any number (for example, 1, 2, 3, 4, 5, 6, or more) of heat-resistant yarn, electro-insulating sheet or grounding conductor could be used to manufacture the present electric heating yarns without departing from the principles and spirits of the present invention.

Illustrative examples of the materials suitable for use as the grounding conductor 440 include, but are not limited to: a copper fiber/yarn, a copper alloy fiber/yarn, an aluminum fiber/yarn and an aluminum alloy fiber/yarn.

In yet another aspect, the present invention is directed to an electric heating textile that is operable to provide a heating temperature higher than 60° C.

According to one embodiment of the present invention, the electric heating textile comprises a textile main body consisting of a plurality of electric heating yarns according to the aspect/embodiments of the present invention as described hereinabove.

In practice, the textile main body is fabricated by knitting or weaving the plurality of electric heating yarns according to the embodiments of the present invention, such as the above-described electric heating yarns 100, 300, 400 or 450.

The electric heating textile may have at least one electrode electrically coupled at least one of the electro-conductive yarn cores of the electric heating yarn and an external power supply.

According to embodiments of the present invention, the electric heating textile may further comprise a lining layer and a heat-insulating layer sandwiched between the textile main body and the lining layer.

As described hereinabove, the textile main body is manufactured from electric heating yarns operable to provide a heating temperature higher than 200° C., and hence, the heat-insulating layer is employed to reduce the heat being conducted to the non-heating side of the electric heating textile (such as the exterior or bottom of the electric heating textile) so that the object (such as a table or a user's hands) in contact with the non-heating side of the electric heating textile would not be overheated or burnt.

Generally, the heat-insulating layer is made of fibers/yarns selected from any one of: oxidized fibers/yarns, aromatic polyamide fibers/yarns, ceramic fibers/yarns and a combination thereof. Specifically, the aromatic polyamide fibers/yarns may be poly(m-phenylene isophthalamide) (e.g., NOMEX® fiber), poly(p-phenylene terephthalamide) (e.g., KEVLAR® fiber), or co-poly(para phenylene/3,4′-oxydiphenylene terephthalamide) (e.g., TECHNORA®fiber).

Optionally, the lining layer is employed so that the electric heating textile may exhibit a more appealing appearance. Examples of the materials suitable for forming the lining layer may include, but are not limited to nylon fibers/yarns, polyethylene terephthalate fibers/yarns, natural fibers/yarns or a combination thereof.

Some experiments were conducted to verify the heating and insulating properties of various electric heating yarns according to embodiments of the present invention. The heating temperatures provided by the electric heating yarns were measured by a thermographic camera to measure the temperature of the surface of the fiber.

If an electric heating yarn is not electrically insulated, it may generate a resistance when being put in the water. Hence, a precision ohmmeter (detection sensitivity: 100 mΩ) was used to measure the resistance of a water tank containing an electric heating yarn. Specifically, one terminal of the resistivity meter was connected to the conductive fiber, and the other terminal was inserted in the water to detect the insulativity of the fiber. An elevation of the resistivity of the water illustrates that the conductive fiber is not perfectly insulated. As such, the longer the time lapsed between the beginning of the test and the time when the resistivity of the water is elevated, the better the waterproof ability of the fiber.

The electro-conductive yarn core of the electric heating yarns of the working examples was stainless steel multifilament yarn, and the electro-conductive yarn core was wound or braided by various materials as summarized in Table 1. Also, the heating and waterproof properties of the electric heating yarns are summarized in Table 1.

TABLE 1

| | 1^{st} | 2^{nd} | | | |
|---|---|---|---|---|---|
| | protective | protective | Grounding | Heating | Waterproof |
| | envelope | envelope | conductor | Temp. (° C.) | ability (days) |
| A | TECHNORA | no | Copper | 206.3 | >30 |
| B | TEFLON | no | no | 300.5 | >30 |
| C | PBO | no | Copper | 202.5 | >30 |
| D | PBO | PBO | Copper | 209.2 | >30 |

For example, the stainless steel multifilament yarn was braided by four TECHNORA yarns to form the first protective envelope, and then, four copper yarns were braided around the first protective envelope, thereby producing the electric heating yarn of working example A. In working example B, the stainless steel multifilament yarn was wound by a TEFLON strap (sheet) to form the first protective envelope.

The data shown in Table 1 establish that the electric heating yarns according to various embodiments of the present invention is capable of providing a heating temperature of at least about 200° C. Also, test results show that no significant elevation of resistivity of water was detected even after thirty days. As such, the electric heating yarns of working examples A-D exhibit desirable waterproof ability.

It will be understood that the above description of embodiments is given by way of example only and that various modifications may be made by those with ordinary skill in the art. The above specification, examples and data provide a complete description of the structure and use of exemplary embodiments of the invention. Although various embodiments of the invention have been described above with a certain degree of particularity, or with reference to one or more individual embodiments, those with ordinary skill in the art could make numerous alterations to the disclosed embodiments without departing from the spirit or scope of this invention.

What is claimed is:

1. An electric heating yarn, comprising:
an electro-conductive yarn core; and
a first protective envelope directly disposed around and completely covering the peripheral of the electro-conductive yarn core such that the electric heating yarn is operable to withstand a temperature of at least about 200° C., wherein the first protective envelope is made of at least one heat-resistant yarn or at least one electro-insulating sheet wound or braided around the peripheral of the electro-conductive yarn core.

2. The electric heating yarn of claim 1, wherein the electro-conductive yarn core is a multifilament yarn.

3. The electric heating yarn of claim 1, wherein the electro-conductive yarn core is selected from the group consisting of: a stainless steel fiber, a carbon fiber, a Ni—Cr fiber, and a combination thereof.

4. The electric heating yarn of claim 1, wherein the heat-resistant yarn is selected from the group consisting of: a quartz fiber/yarn, a glass fiber/yarn, an oxidized fiber/yarn, an alumina fiber/yarn, a poly-p-phenylenebenzobisoxazole fiber/yarn, a poly(m-phenylene isophthalamide) fiber/yarn, a poly(p-phenylene terephthalamide) fiber/yarn, a co-poly(para phenylene/3,4′-oxydiphenylene terephthalamide) fiber/yarn, and a combination thereof.

5. The electric heating yarn of claim 1, wherein the electro-insulating sheet comprises a material selected from the group consisting of: polyimide, polytetrafluoroethylene, and a combination thereof.

6. The electric heating yarn of claim 1, further comprising a second protective envelope disposed around the peripheral of the first protective envelope, wherein the second protective envelope is made of at least one heat-resistant yarn wound or braided around the peripheral of the first protective envelope.

7. The electric heating yarn of claim 1, further comprising a grounding conductor wound or braided around the peripheral of the first protective envelope, wherein the grounding conductor is selected from a group consisting of: a copper fiber/yarn, a copper alloy fiber/yarn, an aluminum fiber/yarn, an aluminum alloy fiber/yarn, and a combination thereof.

8. The electric heating yarn of claim 6, further comprising a grounding conductor wound or braided around the peripheral of the second protective envelope, wherein the grounding conductor is selected from a group consisting of: a copper fiber/yarn, a copper alloy fiber/yarn, an aluminum fiber/yarn, an aluminum alloy fiber/yarn, and a combination thereof.

9. A method for manufacturing an electric heating yarn of claim 1, comprising steps of:
providing an electro-conductive yarn core;
forming a first protective envelope around the electro-conductive yarn core by winding or braiding at least one heat-resistant yarn or electro-insulating sheet directly around the electro-conductive yarn core thereby completely covering the peripheral of the electro-conductive yarn.

10. The method for manufacturing an electric heating yarn of claim 9, wherein the electro-conductive yarn core is a multifilament yarn.

11. The method for manufacturing an electric heating yarn of claim 9, wherein the electro-conductive yarn core is selected from the group consisting of: a stainless steel fiber, a carbon fiber, a Ni—Cr fiber, and a combination thereof.

12. The method for manufacturing an electric heating yarn of claim 9, wherein the heat-resistant yarn is selected from the group consisting of: a quartz fiber/yarn, a glass fiber/yarn, an oxidized fiber/yarn, an alumina fiber/yarn, a poly-p-phenylenebenzobisoxazole fiber/yarn, a poly(m-phenylene isophthalamide) fiber/yarn, a poly(p-phenylene terephthalamide) fiber/yarn, a co-poly(para phenylene/3,4′-oxydiphenylene terephthalamide) fiber/yarn, and a combination thereof.

13. The method for manufacturing an electric heating yarn of claim 9, wherein the electro-insulating sheet comprises a material selected from the group consisting of: polyimide, and polytetrafluoroethylene, and a combination thereof.

14. The method for manufacturing an electric heating yarn of claim 9, further comprising a step of:
forming a second protective envelope around the first protective envelope by winding or braiding at least one heat-resistant yarn around the peripheral of the first protective envelope.

15. The method for manufacturing an electric heating yarn of claim 9, further comprising a step of:
winding or braiding at least one grounding conductor around the peripheral of the first protective envelope, wherein the grounding conductor is selected from a group consisting of: a copper fiber/yarn, a copper alloy fiber/yarn, an aluminum fiber/yarn, an aluminum alloy fiber/yarn, and a combination thereof.

16. The method for manufacturing an electric heating yarn of claim 14, further comprising a step of:
winding or braiding at least one grounding conductor around the peripheral of the second protective envelope, wherein the grounding conductor is selected from a group consisting of: a copper fiber/yarn, a copper alloy fiber/yarn, an aluminum fiber/yarn, an aluminum alloy fiber/yarn, and a combination thereof.

17. An electric heating textile, comprising a textile main body consisting of a plurality of electric heating yarns of claim 1.

18. The electric heating textile of claim 17, wherein the textile main body is fabricated by knitting or weaving the plurality of electric heating yarns.

19. The electric heating textile of claim 17, further comprising at least one electrode electrically coupled at least one of the electro-conductive yarn cores of the electric heating yarn and an external power supply.

20. The electric heating textile of claim 17, further comprising:
a heat-insulating layer made of fibers/yarns selected from any one of: oxidized fibers/yarns, aromatic polyamide fibers/yarns, ceramic fibers/yarns and a combination thereof; and
a lining layer made of fibers/yarns, selected from the group consisting of: nylon fibers/yarns, polyethylene terephthalate fibers/yarns, natural fibers/yarns and a combination thereof,
wherein the heat-insulating layer is sandwiched between the textile main body and the lining layer.
